(19) United States
(12) Patent Application Publication
(10) Pub. No.: US 2011/0114199 A1
(43) Pub. Date: May 19, 2011

(54) ACTUATOR MOUNTING ASSEMBLY

(76) Inventors: Thomas M. Gosling, Kitchener (CA); Alesandro Rosada, Toronto (CA)

(21) Appl. No.: 12/620,702

(22) Filed: Nov. 18, 2009

(51) Int. Cl. F16K 51/00

(52) U.S. Cl. 137/315.35

(57) ABSTRACT

A mounting bracket for locating an actuator in a predetermined position relative to a valve at least partially controlled by the actuator. The mounting bracket includes a body element and three or more arms attached to the body element. Each arm extends between an inner end attached to the body element and an outer end distal to the body element, the outer ends of said at least three arms being positioned to define a plane on which the actuator is locatable, to maintain the actuator in the predetermined position.

### FIELD OF THE INVENTION

The present invention is a mounting bracket for an actuator controlling a valve.

### BACKGROUND OF THE INVENTION

An actuator mounting bracket, for locating an actuator relative to a valve, is well known in the art. A typical actuator mounting bracket of the prior art is illustrated in FIGS. 1A and 1B. (As will be described, the balance of the drawings illustrate the present invention). As is well known in the art, an actuator 10 for a valve 12 is required to be supported by an actuator mounting bracket 14, so that the actuator 10 may be securely attached to a valve stem 16 of the valve 12. The known bracket 14 supports the actuator 10 in a predetermined location relative to the valve 12. Because the actuator 10 acts upon the valve stem 16 to cause the valve 12 to function as required, the actuator mounting bracket 14 is required to maintain the actuator 10 in the predetermined location relative to the valve 12.

In FIGS. 1A and 1B, the typical actuator mounting bracket 14 is shown to include two side elements 18, 20 joined by an upper element 22 (FIG. 1B). At lower ends 24, 26 of the respective side elements 18, 20, the prior art bracket 14 is securely attached to a housing 28 for the valve 12. The actuator 10 is securely attached to the upper element 22. A coupling 30 extends from the actuator 10 and, in order for the actuator 10 to operate, the coupling 30 is securely attached to the valve stem 16, as is well known in the art. The valve 12 is located in a pipe 32.

The conventional mounting bracket 14 has certain disadvantages. In particular, the typical mounting bracket 14 does not work well in all possible orientations relative to the horizontal and/or the vertical. The pipe 32 may be oriented in many ways, and as a result, the valve 12 and the actuator 10 may be located in any orientation relative to the horizontal and/or the vertical upon installation, depending on the design of the system. The bracket 14 is required to support the actuator 10 in the predetermined location relative to the valve 12 regardless of the orientation of the pipe. However, and as illustrated in FIG. 1B, the conventional mounting bracket 14 is not capable of withstanding the stresses to which it is subjected in certain orientations. The consequences can be serious, as the failure of the mounting bracket 14 may ultimately result in a failure to control of the valve properly. For example, if the actuator is not maintained in the predetermined position relative to the valve, then the valve may not open when it should, and/or the valve may stay open when it should stay closed, possibly leading to serious damage.

### SUMMARY OF THE INVENTION

For the foregoing reasons, there is a need for an actuator mounting bracket which addresses or mitigates one or more of the defects of the prior art.

In its broad aspect, the invention provides a valve assembly including a valve with a valve stem extending therefrom, an actuator for controlling the valve, the actuator being connected to the valve stem, and a mounting bracket for supporting the actuator in a predetermined position relative to the valve. The mounting bracket includes three or more arms defining a plane on which the actuator is located to maintain the actuator in the predetermined position.

In another aspect, the mounting bracket additionally comprises a mounting plate receivable on the arms, for engaging the actuator to locate the actuator in the predetermined position.

In yet another aspect, arms include notches respectively in which preselected portions of the mounting plate are received.

In another of its aspects, the invention provides a mounting bracket for locating an actuator in a predetermined position relative to a valve at least partially controlled by the actuator. The mounting bracket includes a body element and three or more arms attached to the body element. Each arm extends between an inner end attached to the body element and an outer end distal to the body element. The outer ends of the arms are positioned to define a plane on which the actuator is locatable, to maintain the actuator in the predetermined position.

### BRIEF DESCRIPTION OF THE DRAWINGS

The invention will be better understood with reference to the attached drawings, in which:

FIG. 1A (also described previously) is a side view of a mounting bracket of the prior art in which an actuator is supported by the bracket in a predetermined position relative to the value;

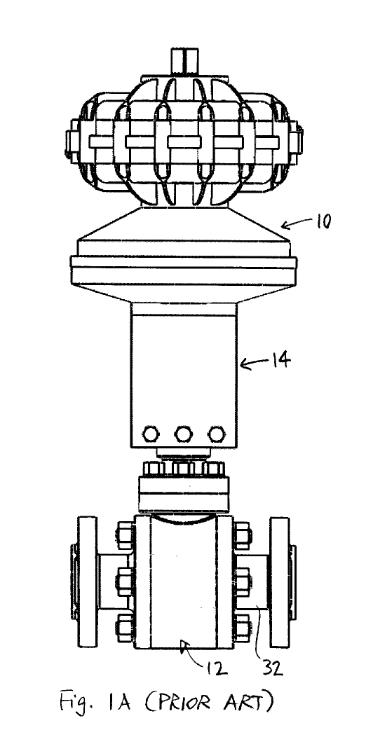

FIG. 1B (also described previously) is another side view of the prior art mounting bracket of FIG. 1A;

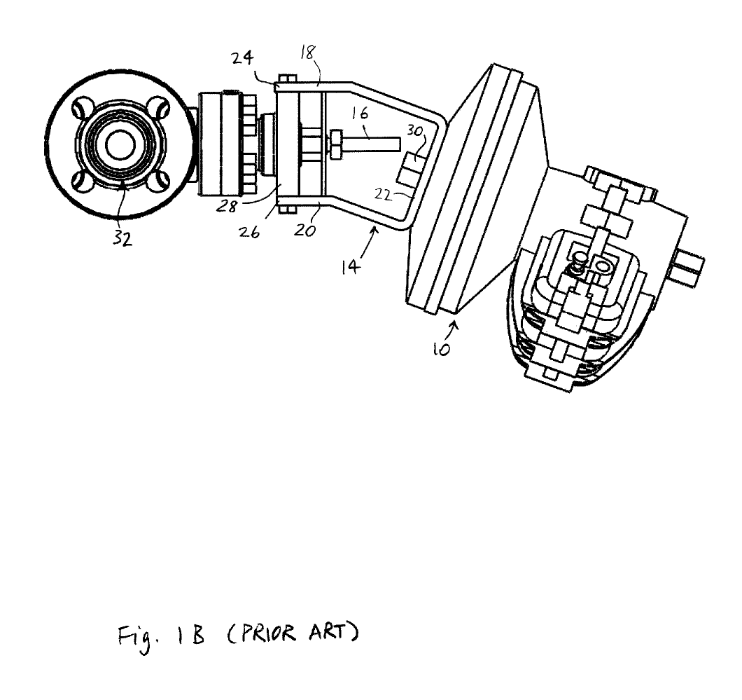

FIG. 2A is a side view of an embodiment of a valve assembly of the invention;

FIG. 2B is a side view of the valve assembly of FIG. 2A in which the pipe in which the valve is located is vertically oriented;

FIG. 2C is a side view of the valve assembly of FIGS. 2A and 2B in which the valve assembly is horizontally oriented;

FIG. 3A is an isometric view of an embodiment of the mounting bracket of the invention in which the mounting bracket is positioned on the valve, drawn at a larger scale;

FIG. 3B is an isometric view of the mounting bracket and valve of FIG. 3B in which a coupler is positioned on the valve stem;

FIG. 3C is an isometric view of the mounting bracket and valve of FIG. 3B additionally including a mounting plate attached to the mounting bracket;

FIG. 4A is a side view of an embodiment of the mounting bracket of the invention, drawn at a larger scale;

FIG. 4B is a top view of the mounting bracket of FIG. 4A;

FIG. 4C is an isometric view of the mounting bracket of FIGS. 4A and 4B;

FIG. 4D is a top view of the mounting bracket of FIG. 4B with the mounting plate positioned thereon; and

FIG. 5 is a side view of another embodiment of the valve assembly of the invention, drawn at a smaller scale.

### DETAILED DESCRIPTION

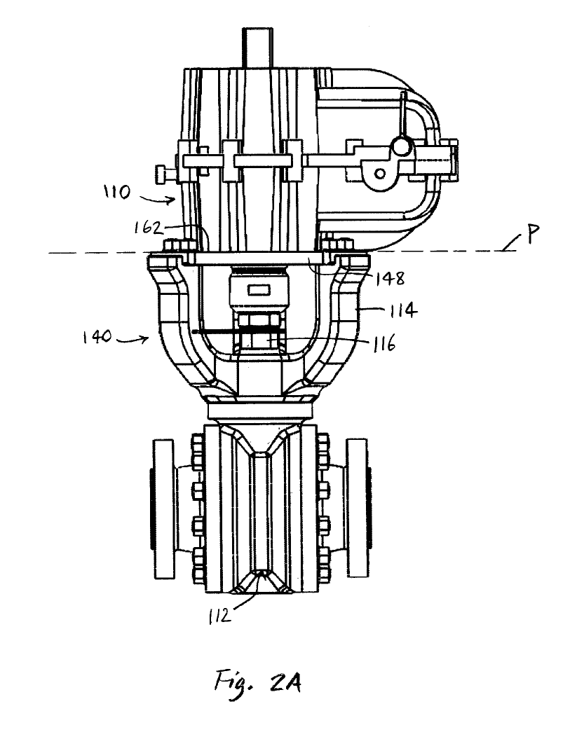

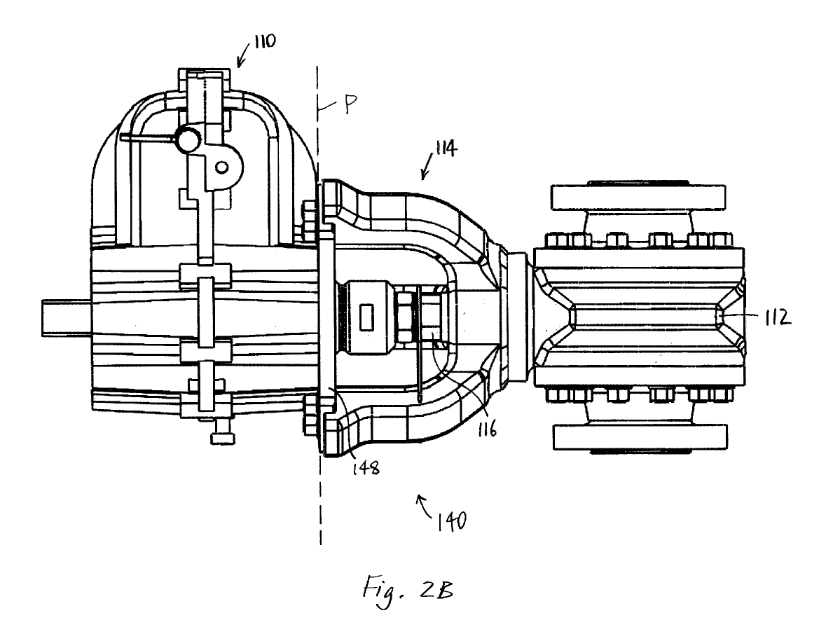

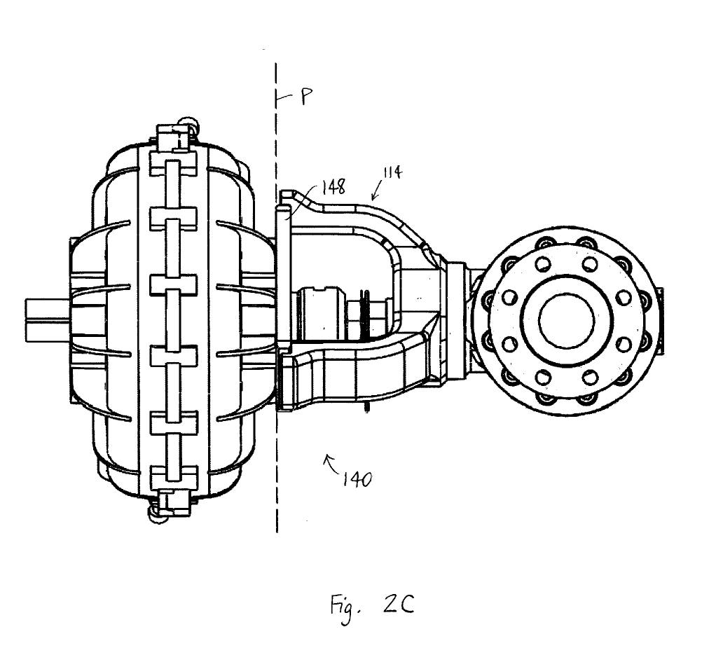

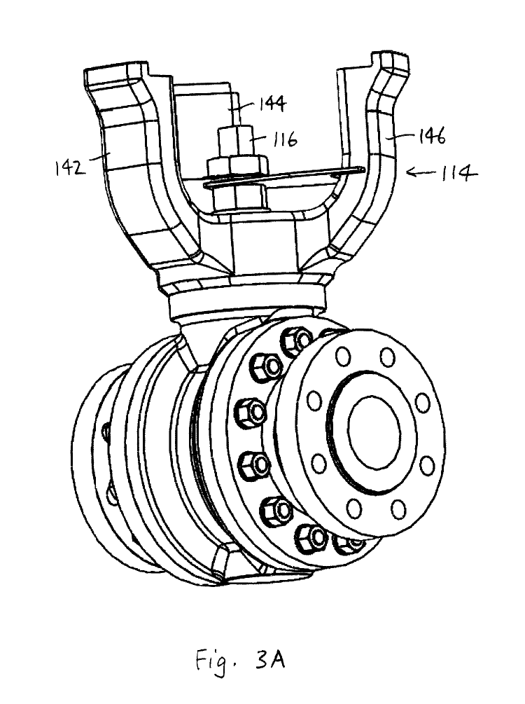

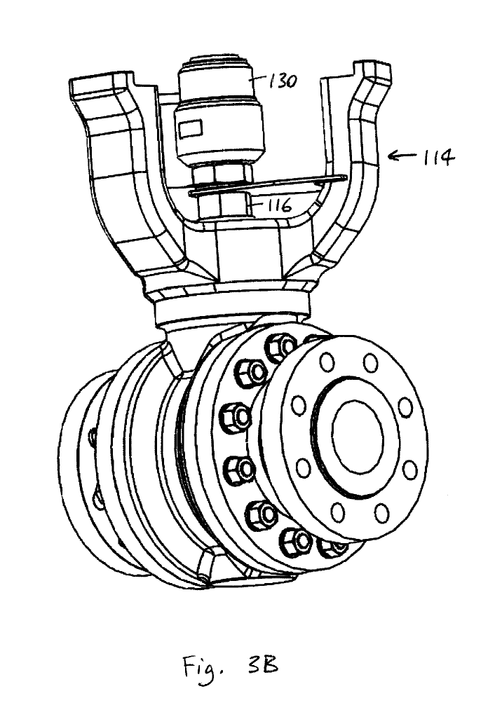

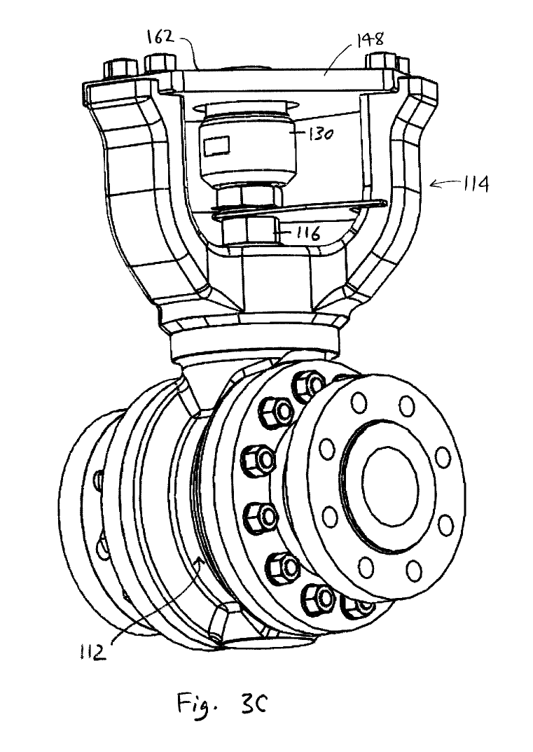

Reference is first made to FIGS. 2A-3C to describe an embodiment of a valve assembly in accordance with the invention indicated generally by the numeral 140. As can be seen in FIGS. 2A-2C, the valve assembly 140 includes a valve 112 with a valve stem 116 extending therefrom and an actuator 110 for controlling the valve 112. Preferably, the actuator 110 is connected to the valve stem 116. It is also preferred that the valve assembly 140 includes a mounting bracket 114 for supporting the actuator 110 in a predetermined position relative to the valve 112, as will be described. The mounting bracket 114 preferably includes three or more arms 142, 144, 146 (FIG. 3A) defining a plane (identified as “P” in FIGS. 2A-2C) on which the actuator 110 is located to maintain the actuator 110 in the predetermined position.

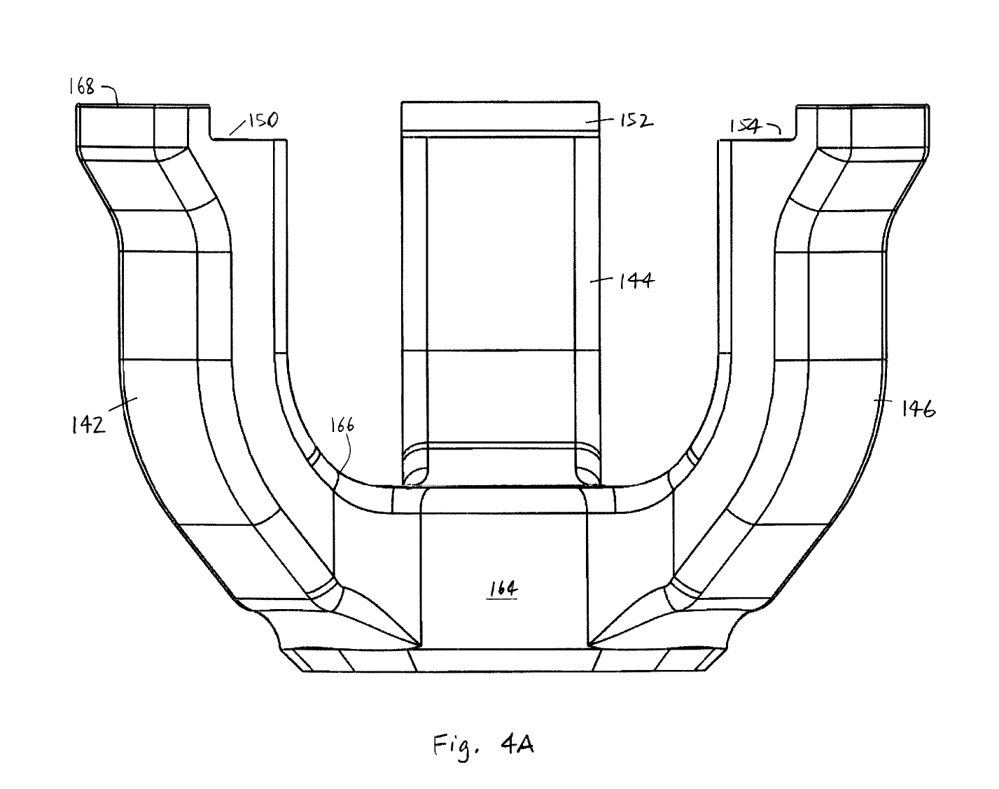

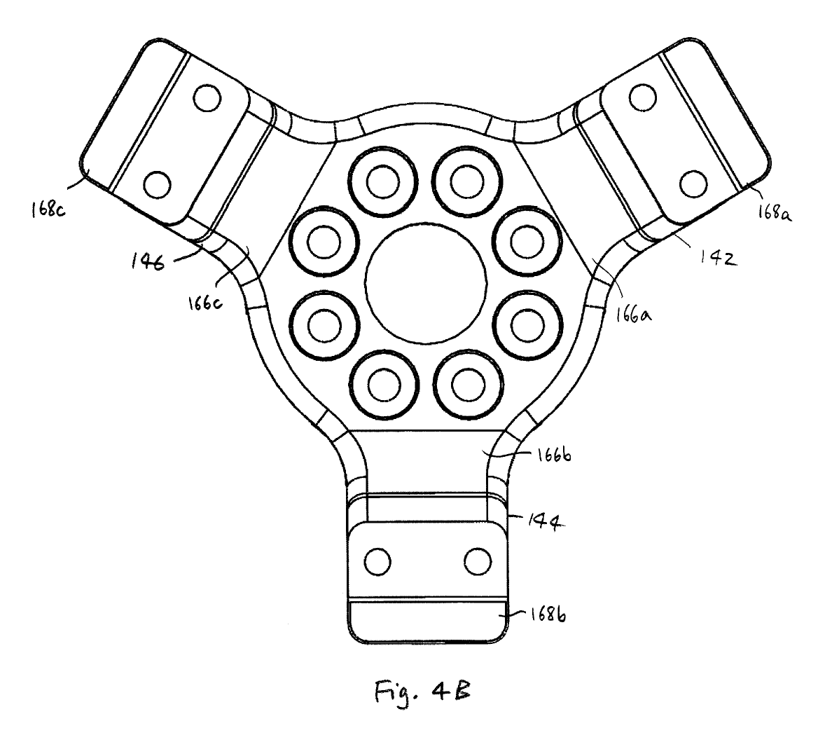

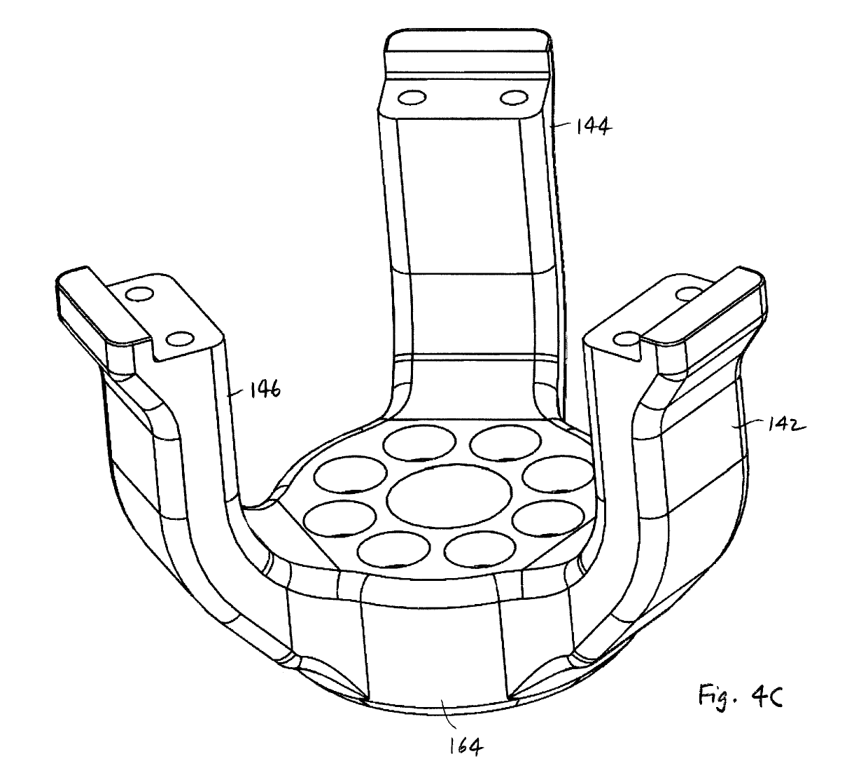

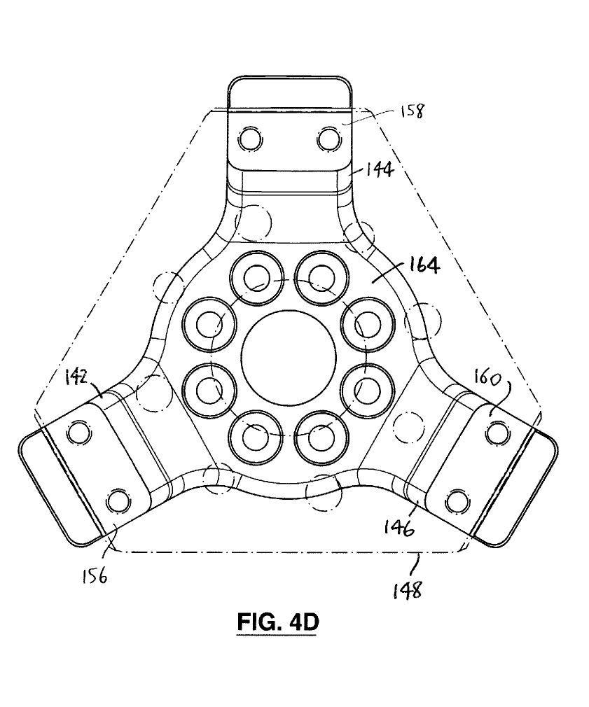

The mounting bracket 114 is illustrated in FIGS. 4A-4C. As can be seen, for instance, in FIG. 4B, the three arms 142, 144, 146 preferably are positioned substantially radially equidistant from each other. It is preferred that the three arms 142, 144, 146 are radially spaced apart from each other by approximately 120°.

In one embodiment, the mounting bracket 114 additionally includes a mounting plate 148 receivable on the three arms 142, 144, 146, for engaging the actuator 110 to locate the actuator 110 in the predetermined position.

Preferably, the three arms 142, 144, 146 also include notches 150, 152, 154 respectively in which preselected portions 156, 158, 160 of the mounting plate 148 are received (FIG. 4D). As can be seen in FIG. 2A, when the mounting plate 148 is positioned at least partially in the notches, a top surface 162 of the mounting plate 148 preferably is located substantially in the plane P. (It will be understood that the mounting plate 148 is shown in FIG. 4D in dashed lines for clarity of illustration).

In one embodiment, the mounting bracket 114 preferably includes a body element 164. Each of the arms 142, 144, 146 preferably extends between an inner end 166 thereof, attached to the body element 164, and an outer end 168, distal to the body element 164 (FIG. 4A). As can be seen in FIG. 2A, the outer ends 168 preferably are positioned to define the plane P. For the purposes of illustration, the inner ends of the arms 142, 144, 146 are designated as 166a, 166b, and 166c respectively, and the outer ends of the arms are also designated 168a-168c in FIG. 4B.

In use, the body element 164 of the mounting bracket 114 is positioned appropriately relative to the valve stem 116 and the valve 112, the body element 164 being attached to the housing 128 of the valve 112 by any suitable means. If the mounting plate 148 is to be used, it is positioned on the arms 142, 144, 146, the portions 156, 158, 160 being positioned on the notches 150, 152, 154 (FIG. 4D). Preferably, the mounting plate 148 is secured to the upper ends of the arms by any suitable means, e.g., by any suitable fasteners. The mounting plate 148 preferably is secured to the arms 142, 144, 146 in any suitable manner. To connect the actuator 110 to the valve stem 116, any suitable means may be used. It is preferred that a suitable coupling 130 be used. The actuator 110 preferably is attached to the mounting plate 148 by any suitable means. For example, the actuator 110 may be attached to the mounting plate 148 by any suitable fasteners (not shown).

The support provided to the actuator on the plane P defined by the three arms of the mounting bracket is very strong and stable. The mounting bracket 114 is able to maintain the actuator in the predetermined position relative to the valve (and in particular, the valve stem thereof) regardless of the orientation of the actuator and the mounting bracket relative to the vertical and/or to the horizontal.

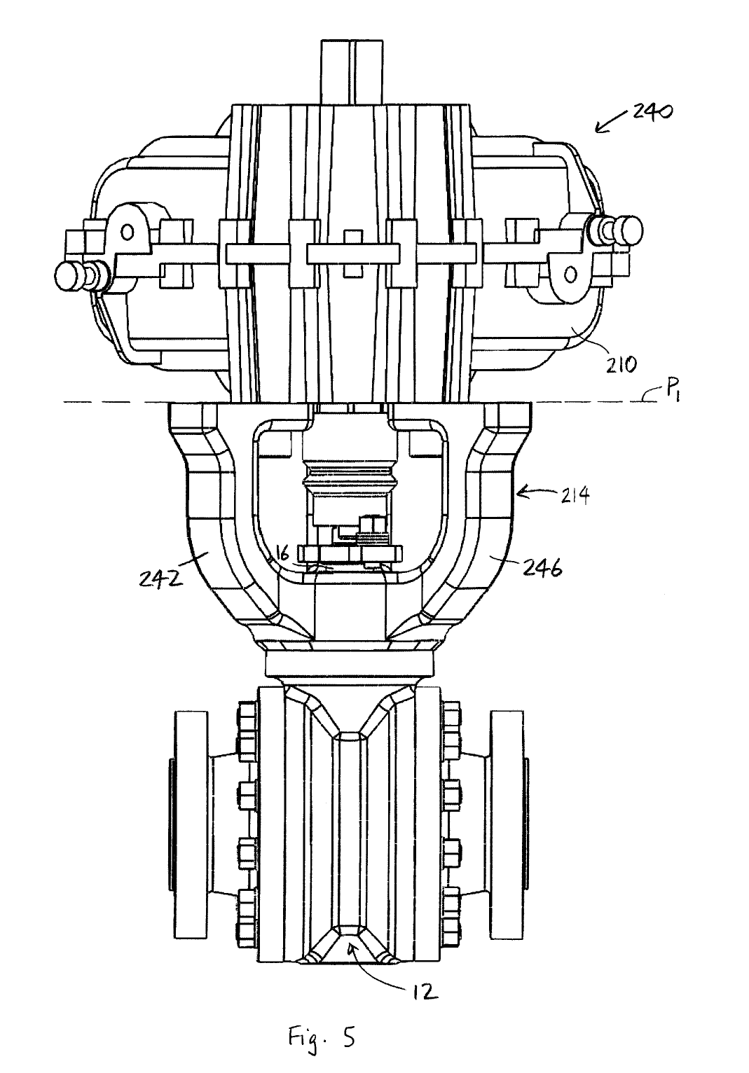

Alternative embodiments of the invention are shown in FIG. 5. In FIG. 5, elements are numbered so as to correspond to like elements shown in FIGS. 2A-4D.

An alternative embodiment of the valve assembly 240 of the invention is illustrated in FIG. 5. As can be seen in FIG. 5, the valve assembly 240 does not include a mounting plate. Preferably, the valve assembly 240 includes the valve 12 with a valve stem 16 extending therefrom. The valve assembly 240 preferably also includes an actuator 210 for controlling the valve. It is also preferred that the valve assembly 240 includes a mounting bracket 214 for supporting the actuator 210 in a predetermined position relative to the valve 12. Preferably, the mounting bracket 214 includes three or more arms defining a plane (designated “P₁” in FIG. 5) on which the actuator is located, to maintain the actuator in the predetermined position.

It will be appreciated by those skilled in the art that the invention can take many forms, and that such forms are within the scope of the invention as claimed. Therefore, the spirit and scope of the appended claims should not be limited to the descriptions of the preferred versions contained herein.

We claim:

1. A valve assembly comprising:
a valve comprising a valve stem extending therefrom;
an actuator for controlling the valve, the actuator being connected to the valve stem; and
a mounting bracket for supporting the actuator in a predetermined position relative to the valve, the mounting bracket comprising at least three arms defining a plane on which the actuator is located to maintain the actuator in the predetermined position.

2. A valve assembly according to claim 1 in which said at least three arms are positioned substantially radially equidistant from each other.

3. A valve assembly according to claim 2 in which said at least three arms are radially spaced apart from each other by approximately 120°.

4. A valve assembly according to claim 1 in which the mounting bracket additionally comprises a mounting plate receivable on said at least three arms, for engaging the actuator to locate the actuator in the predetermined position.

5. A valve assembly according to claim 4 in which said at least three arms comprise notches respectively in which preselected portions of the mounting plate are received.

6. A valve assembly according to claim 1 in which the mounting bracket comprises a body element and each of said at least three arms extends between an inner end, attached to the body element, and an outer end, distal to the body element, the outer ends being positioned to define the plane.

7. A mounting bracket for locating an actuator in a predetermined position relative to a valve at least partially controlled by the actuator, the mounting bracket comprising:
a body element; and
at least three arms attached to the body element, each said arm extending between an inner end attached to the body element and an outer end distal to the body element, the outer ends of said at least three arms being positioned to define a plane on which the actuator is locatable, to maintain the actuator in the predetermined position.

8. A mounting bracket according to claim 7 additionally comprising a mounting plate receivable on said at least three arms, for engaging the actuator to locate the actuator in the predetermined position.

9. A mounting bracket according to claim 8 in which said at least three arms comprise notches respectively in which preselected portions of the mounting plate are received.
